(19) United States
(12) Patent Application Publication
(10) Pub. No.: US 2001/0042297 A1
(43) Pub. Date: Nov. 22, 2001

(54) METHOD FOR PRODUCING LAMINATED METAL TUBES, AND A LAMINATED TUBE AND THE USE THEREOF

(76) Inventors: HEINRICH WOLF, GELNHAUSEN (DE); BERND JESCHONNEK, ERLENSEE (DE)

Correspondence Address: FULBRIGHT & JAWORSKI, LLP, 666 FIFTH AVE, NEW YORK, NY, 10103-3198, US

(21) Appl. No.: 09/311,328

(22) Filed: May 13, 1999

(30) Foreign Application Priority Data
May 28, 1998 (DE) 198 23 832.0

(51) Int. Cl. B23P 11/00

(52) U.S. Cl. 29/458; 29/516

(57) ABSTRACT

For the production of a laminated tube of metal with an outside diameter ranging from 2 to 10 mm, in a first step a metal strip coated on one side (preferably with gold) is placed in a drawing die of a drawing apparatus with fixed internal mandrel, clamped at one end in a movable drawing carriage, and by movement of the drawing carriage is rolled to a tubular insert with a virtually closed gap along the tube axis, the width of the strip corresponding at least approximately to the average circumference of the tubular insert. In a second step the semifinished product shaped as a tubular insert is inserted into an external seamless tube. In a third step the tubes inserted one into the other are clamped each by one end in the drawing carriage of the drawing apparatus and pulled by means of a drawing die with fixed internal mandrel to final dimension (with reduced diameter, the outer tube and the tubular insert being bonded together in a press fit by radial compression.

A method for the production of a laminated tube of metal which is radially compressed by drawing is furthermore recited, according to which the strip with one coated face (preferably gold coating) is placed in a drawing die of a drawing apparatus with fixed internal mandrel and, by movement of the drawing carriage, is rolled to a laminated tube with virtually closed longitudinal gap, the width of the strip corresponding at least approximately to the average circumference of the tubular insert, and the metal strip being guided in the drawing apparatus such that the coated strip face forms the inside surface of the laminated tube to be made.

The laminated tube serves preferably for the transmission of infrared radiation for pyrometric temperature measurement.

The invention relates to a method for producing a laminated tube of metal which has a pipe-like core sheathed in an external seamless tube, the core and external tube being telescoped together and then pressed together radially by drawing, as well as a method for producing a laminated tube of metal which is pressed radially by drawing; the invention furthermore relates to laminated tubes produced by the method and the use of such laminated tubes.

In EP 0 445 904 A2 there is disclosed a method for producing a thick-walled metal high-pressure tube in which first two blank tubes differing in cross-sectional dimensions are telescoped one into the another and then compressed together radially by cold drawing; the shaping is performed preferably by drawing with an internal tool wherein the reduction of the wall thickness, especially that of the inner tube, amounts to a large percentage of the overall shaping, the blank tubes being set one inside the other in the cold solidified state and the double-wall tube thus produced being first heat treated and then drawn cold at least once; after the last cold draw a final heat treatment is performed wherein the first cold draw following after the first heat treatment of the double-wall is performed with an internal tool. The production of such a laminated tube proves to be problematic especially in the miniature range, wherein the inside diameter is to be 2.4 mm, for example, and the outside diameter 4 millimeters; in particular it proves to be problematic to provide the inside tube with an additional coating which can serve a function of guiding radiation by reflection, as disclosed, for example, in German Patent Application 36 05 737 A1. In practice, this would lead to a comparatively complex electroplating of the inside surface of the laminated tube.

In German Patent 597 120 an apparatus for producing tubes from strips of sheet metal is disclosed, in which the sheet metal is drawn over a cylindrical mandrel through a die; the die is configured such that the sheet metal is rolled progressively, beginning from its longitudinal center line, to the diameter of the mandrel.

Also disclosed in German Patent Application 36 30 625 C2 is a method of preparing a tube provided internally with a zinc coating for use in the refrigeration and automotive industry, wherein a strip of sheet metal is galvanized on one side and then shaped into a slotted tube with an internal zinc coating; then this slotted tube is closed using direct current or low-frequency current between a welding roll and a rotating welding electrode while the weld zone is sufficiently flooded with inert gas.

It is the purpose of the invention to describe the production of laminated tubes of small diameter of, for example, 2 to 10 mm and a length of 0.5 to 6 meters; in addition, the tubes are to have a mirror internal surface so as to be able to be used for carrying infrared radiation by reflecting part of the radiation; furthermore, a laminated tube with improved stability and a seamless outer sheath is to be described.

This purpose is accomplished for a first method in that, in a first step a metal strip having a coating of noble metal on at least one face is guided in the drawing apparatus by a stationary internal mandrel such that the coated face of the strip forms the inside surface of the tubular insert to be produced, the metal strip being clamped at one end in a drawing carriage moving with respect to the drawing apparatus and is rolled by the movement of the drawing carriage to form the tubular insert, the width of the strip corresponding at least approximately to the average circumference of the tubular insert; in a second step the unfinished piece shaped as the tubular insert with the coating of noble metal is inserted into the outer tube; then in a third step the tubes inserted one in the other are gripped each at one end in the drawing carriage and are drawn by means of a drawing die with a stationary inner mandrel to the final dimension, the outer tube and the tube-like insert being bonded to one another in a press fit by radial compression.

This especially simple and cost-effective method of production proves to be especially advantageous, while at the same time the laminated tube is given great stability.

In a preferred embodiment of the process, in a first step the tubular insert is shaped to a tube such that its outer circumference has a virtually closed gap along its longitudinal axis; it proves to be advantageous that, on account of the virtually closed gap hardly any damping losses occur in the transmission of the radiation by reflection on the coating of the tube interior if it is intended for use in measuring temperature according to the disclosure DE 36 05 737 referred to above.

In the first step a metal strip with a thickness ranging from 0.1 to 0.8 mm and a width ranging from 6 to 30 mm is rolled to an insert tube, while in the second step the tubular insert with a length ranging from 0.5 m to 6 m is inserted into the seamless outer tube previously made into a semifinished product; the inside diameter of the outer tube is slightly greater than the outside diameter of the insert tube to be placed in it.

What is involved is a relatively simple operation which can advantageously be automated by simple engineering measures.

In the process a metal strip is used which has a coating of noble metal—preferably gold—on at least one face, the strip being carried in the drawing apparatus such that the coated face forms the later inside surface of the tubular insert that is to be made.

It proves in this case to be especially advantageous that a previously prepared metal strip provided with a noble metal or gold coating can be used, which already has the surface necessary for optimum reflective properties, without any later additional electroplating operations. At the same time a comparatively sparing use of noble metal in the coating process can also be achieved. The coating can be produced by electroplating, rolling or sputtering methods, preferably on one side.

In an advantageous embodiment of the third process step, the diameter both of the tubular insert and of the outer tube is reduced by 5 to 50 percent, preferably by 10 to 30 percent. On account of the radial pressing an optimal surface of the noble metal or gold coating of the insert tube can be achieved.

Thus an optimal stability of the laminated tube can be advantageously combined with optimal optical quality.

The problem is solved for a second method of producing a laminated tube of metal that is radially compressed together by drawing is solved in that a metal strip with at least one side coated with noble metal is placed in a drawing die of a drawing apparatus with a fixed internal mandrel, clamped at one end in a drawing carriage that can move with respect to the drawing apparatus, and by moving the drawing carriage is rolled to a laminated tube with a nearly closed longitudinal gap, the width of the strip corresponding at least approximately to the average circumference of the tubular insert, and the metal strip is guided in the drawing apparatus such that the coated side of the strip forms the inner surface of the laminated tube being formed. Also in the second method the coating of the metal strip can be applied by electroplating, roll plating or a sputtering technique.

In a preferred embodiment of the second method, a metal strip with a thickness of 0.1 to 0.8 mm and a width in the range of 6 to 30 mm is rolled to a laminated tube; the laminated tube is preferably drawn in a length up to 6 meters.

The second method proves advantageous in regard to good surface quality in the interior of the tube and the low cost of manufacturing the laminated tube.

For a laminated tube composed of an insert tube and an outer, seamless tube which are pressed radially together, the problem is solved by a drawing procedure of the first method (according to claims 1 to 5) wherein the insert tube has a nearly closed gap running lengthwise of the tube axis.

In an advantageous configuration of the laminated tube, the inside diameter is in the range of 1.5 to 9 mm and its outside diameter in the range of 2 to 10 mm; the internal coating with noble metal or gold has a thickness of at least 0.1 μm; the optical quality of the reflective coating can be considerably improved by the drawing procedure with radial compression that is performed in the third step. Nonferrous metals (brass or copper), noble metal or stainless steel have proven especially appropriate for the tubular insert; nonferrous metals (copper or brass) or stainless steel have proven especially suitable as material for the external seamless tube, these being especially inexpensive materials.

A laminated tube made by the embodiments of claims 6 to 9 can be manufactured at comparatively low cost; it is especially suitable for guiding radiation by means of reflection at the inner surface of the laminated tube.

The problem is solved with regard to the use of the laminated tube for the transmission of radiation along the tube axis by the reflection of at least a portion of the radiation at the internal surface of the laminated tube; in a preferred application the laminated tube is used for the transmission of radiant heat for temperature measurement, as known from German disclosure 36 05 737 A1.

An important advantage of the coating containing noble metal on the inside of the laminated tube is to be seen in its constant reflectivity regardless of temperature.

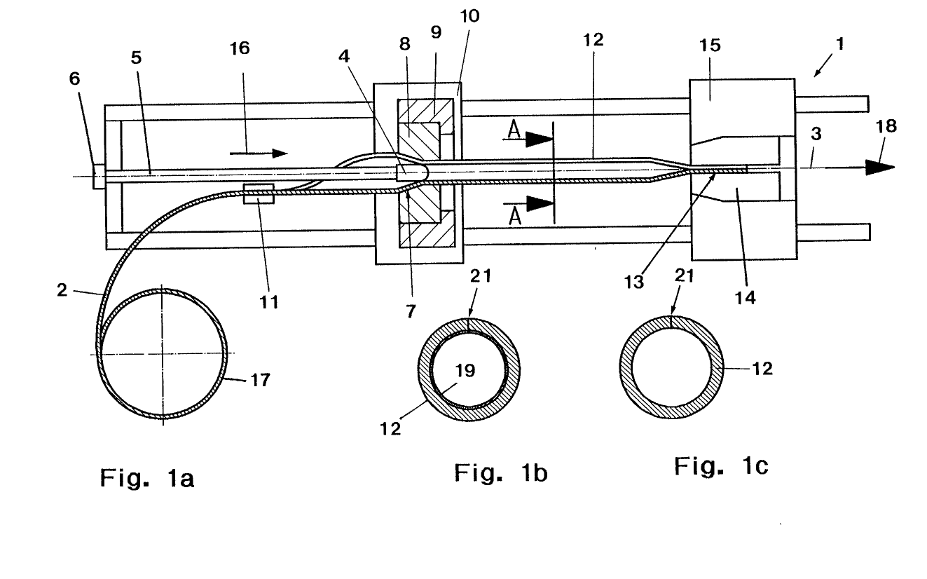

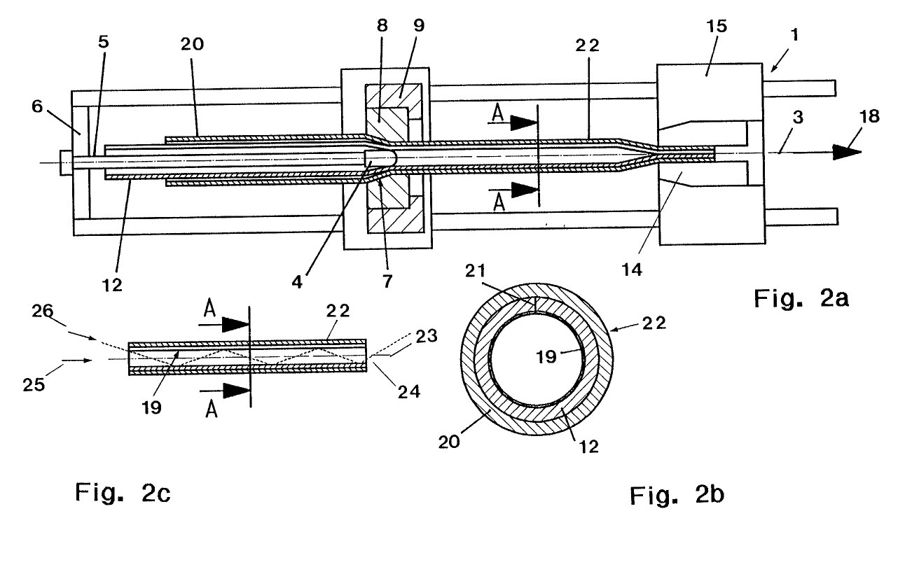

The subject matter of the invention is further explained below with the aid of FIGS. 1a, 1b, 1c and 2a, 2b and 2c.

FIG. 1a shows in longitudinal section a portion of the drawing apparatus to which a metal strip is fed as foreproduct for the formation of a tubular insert and laminated tube.

FIG. 1b shows a cross section through the tubular insert and the laminated tube at the plane of section AA (in FIG. 1a), the inside being provided with a coating.

FIG. 1c shows a tubular insert in the cross section along section plane AA, but it has no internal coating.

FIG. 2a shows a drawing apparatus corresponding to FIG. 1a for forming a laminated tube from the tubular insert and an external seamless tube drawn onto it.

FIG. 2b shows an enlarged cross section through the laminated tube, taken along the section plane AA (in FIG. 2a).

FIG. 2c shows the radiation guidance, known in principle, by means of a laminated tube provided with an internal reflective coating, the radiation guidance having already been described in German Patent 36 05 737 A1.

According to FIG. 1a, the drawing apparatus 1, shown partially, has a drawing mandrel 4 disposed along the drawing axis 3, and it is held in stationary position in the drawing apparatus by the mandrel shaft 5 and its head 6. In the area of entry of the metal strip 2 a strip guiding means 11 is provided. Following in the direction of movement of the metal strip 2, identified by the arrow 16, is the tapering mouth 7 of the drawing die 8, which is held in a fixed position in the drawing apparatus 1 by the die mounting 9 and 10. By means of the drawing mandrel 4 and the drawing die 8 surrounding it at a distance (the distance depends upon the thickness of the metal strip) the metal strip 2 is rolled to a tube or tubular insert 12. The portion of the previously prepared material, shaped to a tubular insert, is clamped at its front end 13 in the chuck 14 of a drawing carriage 15. The direction of transport of the drawing carriage 15 driven by a drive means not shown (chain drive, hydraulic drive) extends along the drawing axis 3. The metal strip 2 in the form of a previously prepared solid or coated foreproduct is carried in an amount sufficient for a plurality of drawing operations on a supply reel 17 from which it is unwound section by section (corresponding to the tube length). By the drawing movement in the direction of arrow 18 the drawing carriage 15 is driven forward to a distance such that the unfinished insert tube or tubular insert 12 will have a length from about 0.5 m to 6 m. For better comprehension, FIG. 1a is represented in a shape that is compressed along the longitudinal axis, so that this figure is by no means to be considered drawn to scale. The tubular insert 12 or insert tube 12 that results after leaving the die 8 is represented in cross section along the plane of section AA in FIG. 1b, this figure indicating a tubular insert 12 with an applied surface coating 19. The nearly closed longitudinal gap is indicated at 21. Gold is preferably provided as the surface coating in order, for example, to permit optimum reflection of the radiation entering the tubular insert or finished laminated tube if the tube is to be used for pyrometric temperature measurement.

The embodiment represented in FIG. 1b is also suitable as a laminated tube without additional external sheathing, whose production is described in claims 6 to 8. Such an arrangement is especially suited for pyrometric temperature measurement.

It is also possible, however, to omit the surface coating of the strip material, as indicated in FIG. 1c. Such an uncoated insert tube can be used, for example, as a foreproduct for the production of a laminated tube with a continuous external sheath for carrying a medium, gas for example, or as a conduit for a coolant. The use of a material resistant to the medium being carried is advantageous in this case.

FIG. 2a again shows the drawing apparatus 1 with drawing mandrel 4, mandrel shaft 5 and mandrel head 6, the drawing mandrel 4 being surrounded at a distance (the distance is determined by the wall thicknesses or final dimension of the laminated tube to be produced) by a die 8 in die holder 9. The feed material is now the insert tube 12 inserted within an external seamless sheath tube 20, both tubes being held by their ends in the chuck 14 of the drawing carriage 15. By the movement of the drawing carriage 15 along the drawing axis 3 in the direction of the arrow 18, the two tubes are pressed together radially toward the drawing axis 3 such that a laminated tube 22 leaves the area of the die 8 in the direction of arrow 18. During compression radially onto the drawing mandrel the surface coating 19 is greatly smoothed so that an optimally reflective internal surface is achieved. The surface coating is indicated by reference number 19 in FIG. 2b.

FIG. 2c shows a longitudinal section of the finished laminated tube. According to FIG. 2c, direct radiation 25 enters along the tube axis 23 and passes without reflection through the laminated tube. Stray radiation 26 (as described for example in DE 36 05 737 A10) is repeatedly reflected at the surface coating 19 within the tube and exits at the tube end 24 into a detector system not represented. The detector system can be, for example, a pyrometer for contact-free temperature measurement.

1. Method for producing a laminated tube from metal, which has a tub-like insert sheathed in an external, seamless tube, the insert and external tube being inserted one into the other and then pressed together radially by drawing, characterized in that in a first step a metal strip which has on at least one flat side a coating of noble metal, is guided in the apparatus with stationary internal mandrel such that the coated strip side forms the inner surface of the tubular insert to be produced, the metal strip being held by one end in a drawing carriage movable with respect to the drawing apparatus and rolled by movement of the drawing carriage to form the tubular insert, the width of the strip corresponding at least approximately to the average circumference of the tubular insert,
that in a second step the semiproduct in the shape of a tubular insert is inserted into the external tube, and
that in a third step the combined tubes are clamped together by one end of each in the drawing carriage and drawn by means of the drawing die with fixed interior mandrel to final dimension, the external tube and tubular insert being bonded together by radial compression.

2. Method according to claim 1, characterized in that in the first step the tubular insert is formed as an insert tube whose tube circumference has a virtually closed gap along the tube's longitudinal axis.

3. Method according to claim 1 or 2, characterized in that in the first step a metal strip with a thickness in the range from 0.1 to 0.8 mm and a width in the range from 6 to 30 mm is rolled to form an insert tube.

4. Method according to any one of claims 1 to 3, characterized in that in the second step the tubular insert is inserted with a length in the range from 0.5 m to 6 m into the external tube.

5. Method according to any one of claims 1 to 4, characterized in that in the third step the diameter both of the tubular insert and of the sheath tube are reduced by 5 to 50%.

6. Method for producing a laminated tube of metal which is compressed together radially by drawing, characterized in that a metal strip with one face coated with noble metal is placed into a drawing die of a drawing apparatus with fixed internal mandrel, is gripped by one end in a drawing carriage movable with respect to the drawing apparatus and by movement of the drawing carriage is rolled to a laminated tube with a virtually closed longitudinal gap, the width of the strip corresponding at least approximately to the average circumference of the tubular insert and the metal strip being guided in the drawing apparatus such that the coated side of the strip forms the inside surface of the laminated tube that is to be made.

7. Method according to claim 6, characterized in that a metal strip with a thickness in the range from 0.1 to 0.8 mm and a width in the range from 6 to 30 mm is rolled to form the laminated tube.

8. Method according to claim 6 or 7, characterized in that the laminated tube is drawn with a length up to 6 m.

9. Method according to any one of claims 1 to 8, characterized in that the drawing process or processes are performed at room temperature.

10. Laminated tube produced according to any one of claims 1 to 9, characterized in that the inner surface of the laminated tube is provided with a coating of noble metal.

11. Laminated tube according to claim 10, characterized in that the coating of the laminated tube consists of gold.

12. Laminated tube according to claim 10 or 11, characterized in that the coating has a thickness in the range of at least 0.1 μm.

13. Laminated tube made according to any one of claims 1 to 5, characterized in that the insert tube has a virtually closed gap running along the tube axis.

14. Laminated tube according to claim 13, characterized in that its inside diameter is in the range from 1.5 to 9 mm and its outside diameter in the range from 2 to 10 mm.

15. Laminated tube according to claim 13 or 14, characterized in that nonferrous metal, especially brass or copper, noble metal or stainless steel is used as material for the tubular insert.

16. Laminated tube according to any one of claims 13 to 15, characterized in that stainless steel or nonferrous metal, especially copper or brass is used for the outer tube.

17. Laminated tube made according to any one of claims 6 to 9, characterized in that its inside diameter is in the range from 1.5 to 9 mm and its outside diameter in the range from 2 to 10 mm.

18. Use of a laminated tube according to any one of claims 10 to 17 for the transmission of radiation along the tube axis by reflection of at least a portion of the radiation at the inside surface of the laminated tube.

19. Use of a laminated tube according to claim 18 for the transmission of infrared radiation for temperature measurement.
